(19) United States
(12) Patent Application Publication
(10) Pub. No.: US 2012/0254909 A1
(43) Pub. Date: Oct. 4, 2012

(54) SYSTEM AND METHOD FOR ADJUSTING PRESENTATION CHARACTERISTICS OF AUDIO/VIDEO CONTENT IN RESPONSE TO DETECTION OF USER SLEEPING PATTERNS

(75) Inventor: Dmytro Serdiuk, Kharkiv (UA)

(73) Assignee: ECHOSTAR UKRAINE, L.L.C., Kharkiv (UA)

(21) Appl. No.: 13/514,020

(22) PCT Filed: Dec. 10, 2009
(86) PCT No.: PCT/UA2009/000065

§ 371 Date: Jun. 5, 2012

(51) Int. Cl. H04N 21/258

(52) U.S. Cl. 725/12

(57) ABSTRACT

A method of controlling presentation of content to a user is provided. The method involves the operation of a set-top box device to present audio/video content to the user. The method collects sensor data at the set-top box device, and then determines, from the sensor data, that the user is likely to be asleep. The method continues by initiating, with the set-top box device, at least one change to presentation characteristics associated with the audio/video content. For example, the set-top box device could lower the volume of the presentation device and/or lower the brightness of the display.

### CROSS-REFERENCES TO RELATED APPLICATIONS

This application claims priority to International Application No. PCT/UA2009/000065, filed Dec. 10, 2009.

### TECHNICAL FIELD

Embodiments of the subject matter described herein relate generally to content delivery systems such as satellite video systems. More particularly, embodiments of the subject matter relate to a video services receiver (such as a set-top box) that determines when the user/viewer has fallen asleep.

### BACKGROUND

Most television viewers now receive their video signals through a content aggregator such as a cable or satellite television provider. In a typical scenario, encoded audio/video signals are sent via a cable or wireless data link to the viewer's home, where the signals are ultimately decoded in a set-top box or other consumer device. The decoded signals can then be viewed on a television or other appropriate display as desired by the viewer. Many viewers fall asleep while watching video programming or while listening to audio delivered via a set-top box. A person who has fallen asleep, however, may be startled by the ongoing programming, especially by loud passages, sound effects, or the like. Moreover, continued delivery and presentation of content to a sleeping person is wasteful of energy and unnecessarily contributes to wear and tear of the set-top box components and the presentation devices themselves (e.g., a television set, a monitor, speakers, audio equipment, etc.).

### BRIEF SUMMARY

An exemplary embodiment of a method of controlling presentation of content to a user is provided here. The method operates a set-top box device to present audio/video content to the user, obtains sensor data at the set-top box device, and processes the sensor data with the set-top box device to determine a physiological condition of the user. The method continues by controlling at least one presentation parameter associated with the audio/video content when the physiological condition indicates that the user is likely to be asleep.

Another exemplary method of controlling presentation of content to a user is also provided. This method begins by operating a set-top box device to present audio/video content to the user. The method collects sensor data at the set-top box device, and determines (from the sensor data) that the user is likely to be asleep. The method then initiates, with the set-top box device and in response to the determination that the user is likely to be asleep, at least one change to presentation characteristics associated with the audio/video content.

Also provided is an exemplary embodiment of a system for providing audio/video content to a user. The system includes a set-top box device configured to provide an audio/video program to a presentation device, and at least one sensor communicatively coupled to the set-top box device. The at least one sensor is configured to provide sensor data to the set-top box device. The system also includes a sensor data processing module and a controller module. The sensor data processing module is configured to process the sensor data to determine whether the user is likely to be asleep, and the controller is configured to adjust at least one operating characteristic of the presentation device when the sensor data processing module determines that the user is likely to be asleep.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a video services broadcasting system;

FIG. 2 is a schematic representation of an embodiment of a set-top box device, which is suitable for use in the video services broadcasting system shown in FIG. 1; and

FIG. 3 is a flow chart that illustrates an exemplary embodiment of a sleep-based audio/video content control process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. Moreover, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The techniques and technology described herein can be employed in the context of a video delivery system such as a cable television system, a satellite television system, a computer-based content delivery system, or the like. The disclosed subject matter relates to certain features and functions of a video services receiver (such as a set-top box). In particular, the set-top box is suitably configured to monitor the state of a viewer to determine when the viewer has fallen asleep. When the set-top box determines that the viewer is sleeping, it proceeds by automatically adjusting and/or controlling certain presentation characteristics of the content. For example, the content delivery system can be controlled in one or more of the following ways, without limitation: adjust (lower) the display brightness; adjust (lower) the volume; turn the set-top box off; turn the presentation device(s) off; activate a content recording device; etc.

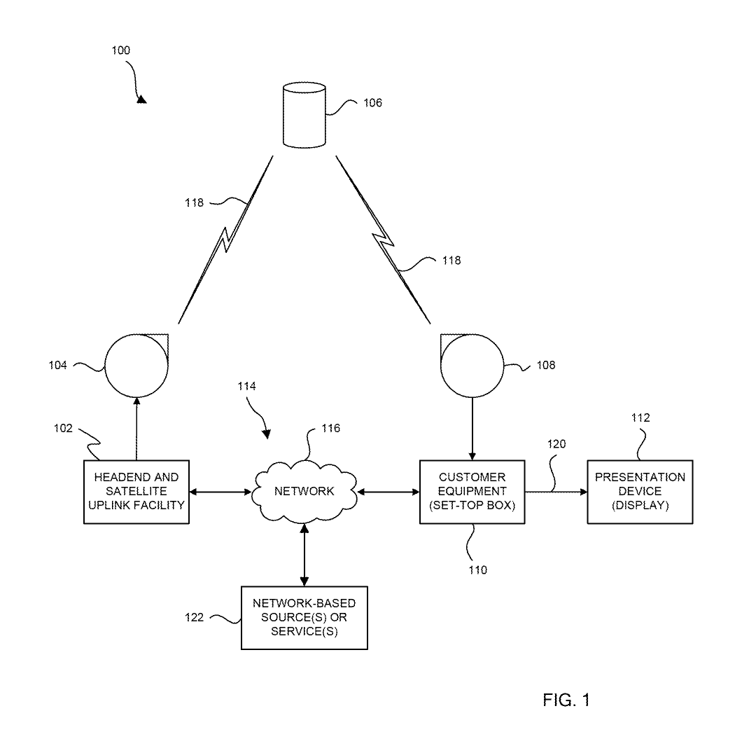

Turning now to the drawings, FIG. 1 is a schematic representation of an embodiment of a video services broadcasting system 100 that is suitably configured to support the techniques and methodologies described below. The system 100 (which has been simplified for purposes of illustration) generally includes, without limitation: a data center 102; an uplink transmit antenna 104; a satellite 106; a downlink receive antenna 108; a video services receiver 110 or other customer equipment; and a presentation device 112 (such as a display, a monitor, a television, audio equipment, or the like). In certain embodiments, the data center 102 communicates with the video services receiver 110 via a back-channel connection 114, which may be established through one or more data communication networks 116. For the sake of brevity, conventional techniques related to satellite communication systems, satellite broadcasting systems, DVB systems, data transmission, signaling, network control, and other functional aspects of the systems (and the individual operating components of the systems) may not be described in detail herein.

The data center 102 may be deployed as a headend facility and/or a satellite uplink facility for the system 100. The data center 102 generally functions to control content and data sent over a high-bandwidth link 118 to any number of downlink receive components (only one downlink receive antenna 108, corresponding to one customer, is shown in FIG. 1). In the embodiment shown in FIG. 1, the high-bandwidth link 118 is a direct broadcast satellite (DBS) link that is relayed by the satellite 106, although equivalent embodiments could implement the high-bandwidth link 118 as any sort of cable, terrestrial wireless and/or other communication link as desired.

The data center 102 includes one or more conventional data processing systems or architectures that are capable of producing signals that are transmitted via the high-bandwidth link 118. In various embodiments, the data center 102 represents a satellite or other content distribution center having: a data control system for controlling content, signaling information, blackout information, and other data; and an uplink control system for transmitting content, signaling information, blackout information, and other data using the high-bandwidth link 118. These systems may be geographically, physically and/or logically arranged in any manner, with data control and uplink control being combined or separated as desired.

The uplink control system used by the system 100 is any sort of data processing and/or control system that is able to direct the transmission of data on the high-bandwidth link 118 in any manner. In the exemplary embodiment illustrated in FIG. 1, the uplink transmit antenna 104 is able to transmit data to the satellite 106, which in turn uses an appropriate transponder for repeated transmission to the downlink receive antenna 108. Under normal operating conditions, the satellite 106 transmits content, signaling data, blackout information, and other data to the downlink receive antenna 108, using the high-bandwidth link 118. In practical embodiments, the downlink receive antenna 108 represents the customer's satellite dish, which is coupled to the video services receiver 110.

The video services receiver 110 can be realized as any device, system or logic capable of receiving signals via the high-bandwidth link 118 and the downlink receive antenna 108, and capable of providing demodulated content to a customer via the presentation device 112. The presentation device 112 may be implemented as, or include, without limitation: a television set; a monitor; a computer display; or any suitable customer appliance with compatible display and/or sound capabilities. In various embodiments, the video services receiver 110 is a conventional set-top box commonly used with DBS or cable television distribution systems. In other embodiments, however, the functionality of the video services receiver 110 may be commonly housed within the presentation device 112 itself. In still other embodiments, the video services receiver 110 is a portable device that may be transportable with or without the presentation device 112. The video services receiver 110 may also be suitably configured to support broadcast television reception, video game playing, personal video recording and/or other features as desired.

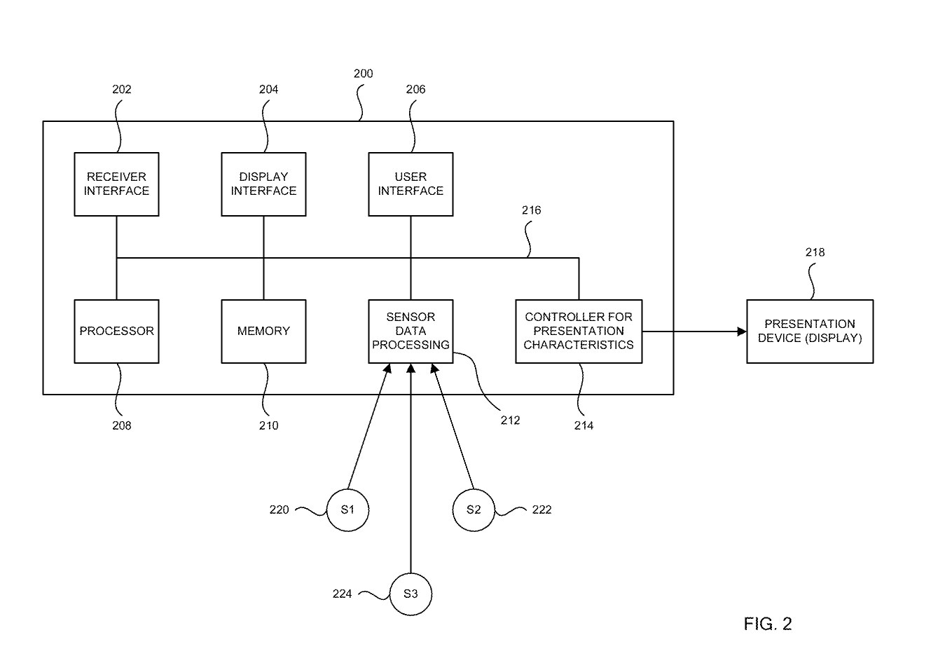

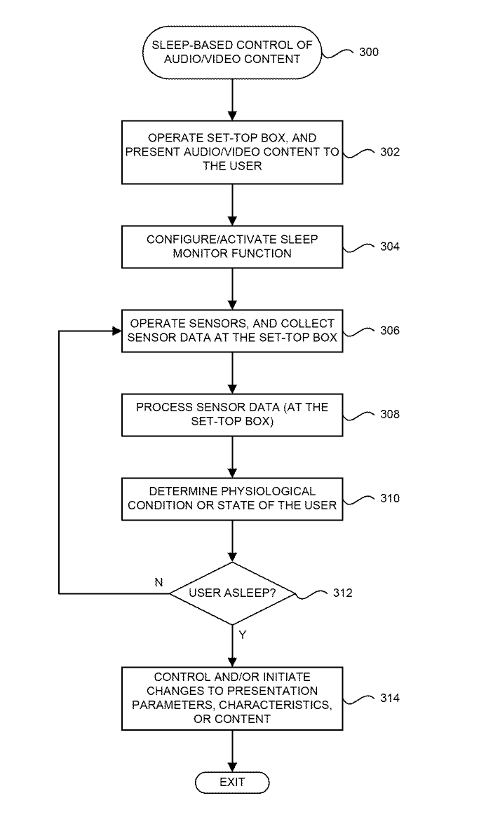

During typical operation, the video services receiver 110 receives programming (broadcast events), signaling information, and/or other data via the high-bandwidth link 118. The video services receiver 110 then demodulates, decompresses, descrambles, and/or otherwise processes the received digital data, and then converts the received data to suitably formatted video signals 120 that can be rendered for viewing by the customer on the presentation device 112. Additional features and functions of the video services receiver 110 are described below with reference to FIG. 2 and FIG. 3.

Certain embodiments of the system 100 may also include or cooperate with any number of network-based content sources and/or any number of network-based services (e.g., content aggregation services, content delivery services, content providers, digital media vendors, or the like). In this regard, FIG. 1 depicts one block that represents these network-based sources or services 122. These network-based sources or services 122 can provide access to media or audio/video content available via the networks 116 (for example, the Internet). If the video services receiver 110 is web-enabled, then it can present web-based audio/video content from the network-based sources or services 122, as is well understood. For example, certain embodiments of the video services receiver 110 could utilize uniform resource locators (URLs) that point to content managed, provided, or otherwise accessible through the network-based sources or services 122. In this regard, the video services receiver 110 could be suitably configured to present streaming media using the presentation device 112.

As mentioned above, the video services receiver 110 could be realized as a set-top box device. In this regard, FIG. 2 is a schematic representation of an exemplary embodiment of a set-top box device 200 suitable for use in a video services broadcasting system, such as the system 100 shown in FIG. 1. The set-top box device 200 is configured to receive video content, and to provide the video content to the customer on an appropriate presentation device, such as the presentation device 112 shown in FIG. 1. This embodiment of the set-top box device 200 generally includes, without limitation: a receiver interface 202; a display interface 204; a user interface 206; at least one processor 208; at least one memory element 210; a sensor data processing module 212; and a controller 214 that controls certain presentation-related parameters, characteristics, and/or features (described in more detail below). These components, modules, and elements may be coupled together as needed for purposes of interaction and communication using, for example, an appropriate interconnect arrangement or architecture 216. In practice, the set-top box device 200 will include additional elements and features that support conventional functions and operations.

As explained above with reference to FIG. 1, the set-top box device 200 may be suitably arranged to cooperate with a presentation device 218, which typically includes or is coupled to a display. In other words, the set-top box device 200 is configured to provide audio/video programs or services to the presentation device 218, as is well understood. In some embodiments, the set-top box device 200 is coupled to the presentation device 218 using a suitable data communication specification, standard, or protocol (such as, for example, the home networking protocols set forth by the Digital Living Network Alliance). For the illustrated embodiment, the display interface 204 is suitably configured to facilitate rendering of video and/or still images on the presentation device 218. Moreover, the controller 214 may be communicatively coupled to the presentation device 218 in an appropriate manner to enable it to adjust at least one operating characteristic, parameter, or feature of the presentation device 218 as needed.

In certain embodiments, the set-top box device 200 can be deployed as part of a system for providing audio/video content to a user, where that system also includes the presentation device 218 and at least one sensor configured to provide sensor data to the set-top box device 200. Accordingly, the embodiment depicted in FIG. 2 also includes a first sensor 220, a second sensor 222, and a third sensor 224, each being communicatively coupled to the set-top box device 200. In practice, these sensors can provide their respective sensor data to the sensor data processing module 212 so that the sensor data can be processed, analyzed, and otherwise handled in the manner described in more detail below.

The receiver interface 202 is coupled to the customer's satellite antenna, and the receiver interface 202 is suitably configured to receive and perform front end processing on signals transmitted by satellite transponders. In this regard, the receiver interface 202 can receive data associated with any number of services. The receiver interface 202 may leverage conventional design concepts that need not be described in detail here. The display interface 204 is coupled to at least the presentation device 218 (and possibly others) at the customer site. The display interface 204 represents the hardware, software, firmware, and processing logic that is utilized to render graphics, images, video, and other visual indicia on the customer's display. The display interface 204 may leverage conventional design concepts that need not be described in detail here. The user interface 206 may include one or more elements, components, or features that accommodate user inputs and/or that provide feedback to the user. For example, the user interface 206 may include, without limitation: keys; buttons; switches; a keyboard; a touchpad; a touch screen; a mouse or equivalent pointing device; indicator lights; or the like.

The processor 208 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor 208 may be realized as a microprocessor, a controller, a microcontroller, or a state machine. Moreover, the processor 208 may be implemented as a combination of computing devices, e.g., a combination of a digital signal processor and a microprocessor, a plurality of microprocessors, one or more microprocessors in conjunction with a digital signal processor core, or any other such configuration. As described in more detail below, the processor 208 (cooperating with the sensor data processing module 212 and the controller 214) may be adapted to change certain presentation characteristics, change the on/off/standby state of the set-top box device 200 and/or the presentation device 218, and/or change the current audio/video content when the set-top box device 200 determines that the user is likely to be asleep.

The memory element 210 may be realized as RAM memory, flash memory, EPROM memory, EEPROM memory, registers, a hard disk, a removable disk, or any other form of storage medium known in the art. In this regard, the memory element 210 can be coupled to the processor 208 such that the processor 208 can read information from, and write information to, the memory element 210. In the alternative, the memory element 210 may be integral to the processor 208. As an example, the processor 208 and the memory element 210 may reside in a suitably designed ASIC. In practice, the memory element 210 can be utilized to store and maintain information, tables, and data as needed to support the sleeping pattern monitoring techniques described herein.

The sensor data processing module 212 may be implemented as part of the processor 208 or as a separate logical component. The sensor data processing module 212 receives or obtains the sensor data (or data derived from the sensor data), and processes the sensor data in an appropriate manner to determine whether the user is likely to be asleep, in a drowsy state, likely to be awake, likely to be in a deep sleep, in the process of falling asleep, or the like. Therefore, the configuration, design, and functionality of the sensor data processing module 212 can differ from one embodiment to another, depending upon the number and/or types of sensors deployed with the set-top box device 200. For example, if a microphone is used to detect breathing (respiration) sounds, then the sensor data processing module 212 will be suitably configured to analyze captured sound data. As another example, if a camera is used as one of the sensors, then the sensor data processing module 212 will include image processing capabilities that enable analysis of captured still or video images. In practical implementations, therefore, the sensor data processing module 212 could include or be associated with one or more software applications that are written to support the desired amount and level of sensor data processing.

The controller 214 may be implemented as part of the processor 208 or as a separate logical component. The controller 214 may be operationally coupled to the sensor data processing module 212 to enable it to respond to the sensor data processing module 212. In this regard, the controller 214 can be suitably configured to take appropriate action when the sensor data processing module 212 determines that the user is likely to be asleep or when the user's condition is otherwise indicative of a particular sleeping/waking state or stage. For example, the controller 214 could adjust at least one operating parameter or characteristic of the presentation device 218, initiate a standby or power-down state of the presentation device 218, initiate a standby or power-down state of the set-top box device 200, and/or control at least one presentation parameter associated with the audio/video content when it has been determined that the user might be sleeping.

Although FIG. 2 depicts three sensors 220, 222, and 224 for this exemplary embodiment, any number of sensors (including only one) could be deployed in an embodiment of the set-top box device 200. A given sensor may include, cooperate with, or be realized as any of the following sensor types, without limitation: a motion detector; a video camera; a still camera; a microphone; a sound meter; a physiological characteristic sensor; a thermometer; a clock; and a light intensity meter. It should be appreciated that other sensor types and configurations could be employed if so desired. Although not shown in FIG. 2, any given sensor could be implemented as an integral component of the set-top box device 200. In other words, a sensor could be considered to be part of the set-top box device 200 itself. As shown in FIG. 2, however, the sensors may be realized as separate physical devices or components that are physically and/or wirelessly coupled to the set-top box device 200. In this regard, a sensor could be connected via cables or wires to accommodate data transfer to the set-top box device 200. In alternate embodiments, a sensor could be realized as a stand-alone device or component, and the set-top box device 200 and that sensor could be compatibly configured to accommodate wireless transmission of sensor data.

A motion detector could employ infrared, laser, or sonic interrogation techniques to scan the environment for movement or motion. Such a motion detector would preferably (but need not be) positioned near the viewing or listening area, and near or integrated into the set-top box device 200. A still or video camera could be used to provide digital image data to the set-top box device 200. The image data could be processed to detect the presence of the user and to determine whether the user's movements are indicative of a sleeping state. In certain embodiments, the image data could also be used to determine whether the user's eyes are open or closed and/or to detect other visual cues that indicate a sleeping state. If used, cameras would preferably (but need not be) positioned near the viewing or listening area, and near or integrated into the set-top box device 200. A microphone could be used to monitor for background noise, voices, breathing patterns, snoring, or other sounds. If used, a microphone would preferably (but need not be) positioned near the viewing or listening area, and one could be located near or integrated into the set-top box device 200. In some embodiments, it might be desirable to locate a microphone near the user, such that breathing and snoring sounds can be detected easily. Similarly, a sound meter could be used to measure sound pressure levels near the set-top box device 200. If used, a sound meter would preferably (but need not be) positioned near the viewing or listening area, and near or integrated into the set-top box device 200.

Some sensors could generate or provide sensor data that is indicative of the time of day and, thus, indicative of normal waking or sleeping hours. For example, a thermometer could be used to measure the outside, inside, or body temperature of the user (where higher outside or inside temperatures suggest daytime hours and lower temperatures suggest nighttime hours). In this regard, a body temperature sensor, an infrared temperature sensor, or other types of thermometers could be used with the system. As another example, a clock can be considered to be a type of sensor that provides the time of day. In this regard, the set-top box device 200 could be configured to assume that certain times of the day correspond to normal sleeping hours, while other times of the day correspond to normal waking hours. As yet another example, a light intensity meter could be used to measure the amount of outside light, the amount of indoor light, and/or the amount of ambient light near the set-top box device 200. In this regard, low levels of light might indicate an environment that is conducive to sleeping.

In certain embodiments, one or more physiological characteristic sensors could be employed by the system. As used here, a physiological characteristic sensor is any sensor, detector, device, or component that is configured to measure a physiologic characteristic of a person. For example, and without limitation, a physiological characteristic sensor could be: a heart rate monitor that obtains user heart rate data; a pedometer or accelerometer that obtains user motion data; a breathing or respiration monitor that obtains user respiration data; a body thermometer that obtains user temperature data; an electrocardiogram (ECG) device; an electroencephalogram (EEG) device; a blood glucose sensor or meter; a blood pressure sensor or monitor; or the like.

A set-top box device configured in the manner described above can be utilized to monitor user sleeping patterns while the user is viewing a program or while listening to audio content provided by the set-top box device. The example described here refers to the detection of a condition that suggests that the user is likely to be asleep. In practice, however, the system could gather and process sensor data to determine any user sleeping or waking state or condition. Accordingly, the set-top box device could be utilized to determine whether or not the user is likely to be asleep, drowsy, fully awake, in a deep sleep, in the process of falling asleep, or the like. In this regard, FIG. 3 is a flow chart that illustrates an exemplary embodiment of a sleep-based audio/video content control process 300, which may be performed by an appropriately configured set-top box device. The various tasks performed in connection with process 300 may be performed by software, hardware, firmware, or any combination thereof For illustrative purposes, the following description of process 300 may refer to elements mentioned above in connection with FIG. 1 and FIG. 2. In practice, portions of process 300 may be performed by different elements of the described system, e.g., a sensor, the set-top box, or a presentation device. It should be appreciated that process 300 may include any number of additional or alternative tasks, the tasks shown in FIG. 3 need not be performed in the illustrated order, and process 300 may be incorporated into a more comprehensive procedure or process having additional functionality not described in detail herein. Moreover, one or more of the illustrated tasks for process 300 could be omitted from an embodiment as long as the intended functionality remains intact.

The illustrated embodiment of process 300 begins by operating the set-top box device to present audio/video content to the user (task 302). The audio/video content may include audio only, video only, still images only, or any combination thereof The audio/video content may be provided by a cable or satellite service provider, by a web-based service, by a digital video recorder device coupled to the set-top box device, by a digital video recorder feature that is embedded or integrated in the set-top box device, or by other suitable means. Although not always required, this embodiment assumes that the user has the ability to configure, initialize, or otherwise activate the sleep monitor function (task 304) of the set-top box device. In such an embodiment, the sleep monitor feature must be activated for it to be effective. In alternate embodiments, the sleep monitor feature could be active by default, or it could always be active and running in the background.

Assuming that the sleep monitor function is active, the process 300 operates the sensors to obtain or collect the corresponding sensor data at the set-top box device (task 306). As mentioned above, a sensor could provide its sensor data to the set-top box device using a tangible data communication link and/or using a wireless data communication link. After receipt at the set-top box device, the sensor data can be processed, analyzed, or otherwise handled in an appropriate manner (task 308). For this exemplary embodiment, most if not all of the sensor data processing is performed locally at the set-top box device (for example, sensor data processing could be executed by the sensor data processing module 212 shown in FIG. 2). Alternatively, most if not all of the sensor data processing could be performed by a system, device, or component other than the set-top box device. In yet other embodiments, the sensor data processing could be distributed between the set-top box device and any number of other systems, devices, or components that are remote from the set-top box device. For instance, some or all of the sensor data processing might be performed by a network-based service, by a server system, at a headend facility, at a central control center, or the like.

In particular embodiments, at least some of the gathered sensor data is processed and analyzed to determine a physiological condition or state of the user (task 310). The physiological condition may be one or more of the following, without limitation: a sleeping state; a waking state; a resting state; an active state; an exercising state; or the like. For this example, the process determines whether the user is likely to be asleep (query task 312), based upon the analysis of the received sensor data. In practice, this determination can be influenced by the analysis of sensor data from any one sensor, or by the combined analysis of sensor data from any plurality of sensors. In preferred embodiments, this determination is influenced and dictated by the analysis of all available sensor data. Use of all sensor data is desirable for the sake of accuracy and to avoid “false positive” results.

If query task 312 determines that the user is not asleep, then the process 300 may exit or it may be re-entered at an appropriate point, such as task 306. If, however, query task 312 determines that the user is likely to be asleep, then the process 300 can proceed to a task 314. The process 300 can arrive at the conclusion that the user is likely to be asleep in any number of different ways. For example, the physiological condition might indicate that the user is likely to be asleep when the user motion data indicates little to no user motion over a particular period of time. In other words, if little to no user movement has been detected during designated period of time (e.g., one minute, five minutes, an hour, etc.), then it might be reasonable for the system to assume that the user has fallen asleep. As another example, the physiological condition might indicate that the user is likely to be asleep when the user heart rate data indicates a drop in heart rate of the user. In practice, the system could employ an appropriate threshold value such that a lower heart rate will not influence the sleep determination unless it has fallen by at least a threshold amount during a specified period of time. Similarly, the physiological condition might indicate that the user is likely to be asleep when user sound data or user respiration data indicates a drop in the respiration rate of the user. In practice, the system could employ an appropriate threshold value such that a lower respiration rate will not influence the sleep determination unless it has fallen by at least a threshold amount during a specified period of time. Sound data could also be used to determine whether the user is snoring. In this regard, the physiological condition might indicate that the user is likely to be asleep when the user sound data is indicative of snoring.

Assuming that query task 312 determines that the user is likely to be asleep, the process 300 continues by controlling and/or initiating changes to certain presentation parameters, display characteristics, or content being presented to the user (task 314). For example, the set-top box device could control at least one presentation parameter associated with the current audio/video content when the physiological condition indicates that the user is likely to be asleep. Alternatively or additionally, the set-top box device could initiate at least one change to presentation characteristics associated with the current audio/video content. More specifically, the set-top box device could initiate an adjustment of at least one setting of the presentation device that is currently being used to present the audio/video content to the user. Alternatively or additionally, the set-top box device could select new audio/video content that is appropriate for a sleeping state of the user, and thereafter initiate the presentation of the new audio/video content. The new audio/video content might be preselected by the user, or it could be automatically chosen by the set-top box device using a content tagging, labeling, or categorization scheme. For example, if the user has fallen asleep, then it may be appropriate to change the audio/video content from an action or adventure movie to an ambient background music score, a classical music concert, or the like.

The particular manner in which the system is automatically adjusted or modified may differ from one embodiment to another, and it may vary depending upon the analysis of the sensor data. For example, in certain scenarios it may be appropriate to adjust a brightness setting of a display being used to present the audio/video content to the user. Typically, this will result in a lower brightness setting because most people prefer to sleep in a dark environment (although a higher brightness setting could be configured if so desired). As another example, it may be appropriate to adjust a volume setting of the presentation device currently being used to present the audio/video content to the user. Typically, this will result in a lower volume setting because most people prefer to sleep in a quiet environment, and to reduce the likelihood that the user will be awakened by loud sounds (although a higher volume setting could be configured if so desired).

In certain embodiments, the set-top box device initiates a standby or power-down state of the presentation device currently being used to present the audio/video content to the user. Thus, if the process 300 determines that the user is likely to be asleep, the presentation device can be shut down or placed into a standby mode. In typical implementations, this will effectively blank the display and mute the sound of the presentation device. Moreover, this has the additional benefit of conserving energy. Similarly, the set-top box device could initiate a standby or power-down state of itself when query task 312 determines that the user is likely to be asleep. Again, this will typically result in blanking of the display and muting of the sound.

If the system includes a recording device, such as a digital video recorder, then the recording device can be activated to record the audio/video content when query task 312 determines that the user is likely to be asleep. Thus, even though the user might be sleeping, he or she will be able to enjoy at least some of the missed content at a later time. Notably, the audio/video content could be recorded in this manner even if the presentation device is shut down or placed into standby mode, and/or if the set-top box device is shut down or placed into its standby mode.

It may also be possible to initiate certain adjustments or commands for other household appliances, components, or features that need not be closely related to the presentation of the audio/video content itself For example, if query task 312 determines that the user is likely to be asleep, then one or more of the following actions could be initiated, without limitation: dimming or turning off light fixtures; adjusting or turning off a heating or air conditioning system; pausing or turning off noisy household appliances such as washers or dryers; adjusting or turning off other presentation devices; adjusting or turning off other audio equipment; or the like. Such control actions may require some form of intercommunication between the set-top box device and the devices or system under its control (for example, a wireless home networking scheme might be appropriate). Moreover, any combination of the control, adjustment, changing, or modification approaches described above could be executed concurrently, sequentially, or otherwise to create a more comfortable sleeping environment for the user.

It should be appreciated that the system described here could also be suitably configured to continue monitoring the state or condition of the user to determine when the user is no longer sleeping. Similar sensor data processing can be performed to detect when the user wakes up and, in response thereto, one or more controls, command, adjustments, changes, or modifications can be initiated or executed as desired to account for the user's wakened state. For example, the volume and brightness of the presentation device can be returned to their previous levels, the user could be prompted to view any recorded content, etc.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of controlling presentation of content to a user, the method comprising:
operating a set-top box device to present audio/video content to the user;
obtaining sensor data at the set-top box device;
processing the sensor data with the set-top box device to determine a physiological condition of the user; and
controlling at least one presentation parameter associated with the audio/video content when the physiological condition indicates that the user is likely to be asleep.

2. (canceled)

3. The method of claim 2, wherein the physiological condition indicates that the user is likely to be asleep when the user motion data indicates little to no user motion over a particular period of time.

4. The method of claim 2, wherein the physiological condition indicates that the user is likely to be asleep when the user heart rate data indicates a drop in heart rate of the user.

5. The method of claim 2, wherein the physiological condition indicates that the user is likely to be asleep when the user sound data indicates a drop in respiration rate of the user.

6. The method of claim 2, wherein the physiological condition indicates that the user is likely to be asleep when the user sound data is indicative of snoring.

7. The method of claim 2, wherein the physiological condition indicates that the user is likely to be asleep when the user respiration data indicates a drop in respiration rate of the user.

8. The method of claim 1, wherein controlling the at least one presentation parameter comprises adjusting a brightness setting of a display being used to present the audio/video content to the user.

9. The method of claim 1, wherein controlling the at least one presentation parameter comprises adjusting a volume setting of a presentation device currently being used to present the audio/video content to the user.

10. The method of claim 1, wherein controlling the at least one presentation parameter comprises initiating a standby or power-down state of a presentation device currently being used to present the audio/video content to the user.

11. The method of claim 1, wherein controlling the at least one presentation parameter comprises initiating a standby or power-down state of the set-top box device.

12. The method of claim 1, wherein controlling the at least one presentation parameter comprises activating a recording device to record the audio/video content.

13. The method of claim 1, wherein controlling the at least one presentation parameter comprises:
selecting new audio/video content that is appropriate for a sleeping state of the user; and
initiating presentation of the new audio/video content.

14. A method of controlling presentation of content to a user, the method comprising:
operating a set-top box device to present audio/video content to the user;
collecting sensor data at the set-top box device;
determining, from the sensor data, that the user is likely to be asleep; and
initiating, with the set-top box device and in response to the determining step, at least one change to presentation characteristics associated with the audio/video content.

15. The method of claim 14, wherein the determining step is performed by the set-top box device.

16. The method of claim 14, wherein the determining step is performed by a system, device, or component other than the set-top device.

17. The method of claim 14, wherein the collecting step collects sensor data selected from the group consisting of: user motion data; user heart rate data; user respiration data; user sound data; user blood pressure data; and user temperature data.

18. The method of claim 14, wherein the initiating step initiates adjustment of at least one setting of a presentation device currently being used to present the audio/video content to the user.

19. A system for providing audio/video content to a user, the system comprising:
a set-top box device configured to provide an audio/video program to a presentation device;
at least one sensor communicatively coupled to the set-top box device, the at least one sensor configured to provide sensor data to the set-top box device;
a sensor data processing module configured to process the sensor data to determine whether the user is likely to be asleep; and
a controller coupled to the sensor data processing module, the controller configured to adjust at least one operating characteristic of the presentation device when the sensor data processing module determines that the user is likely to be asleep.

20. The system of claim 19, wherein the at least one sensor comprises a sensor selected from the group consisting of: a motion detector; a video camera; a still camera; a microphone; a sound meter; a physiological characteristic sensor; a thermometer; a clock; and a light intensity meter.

21. The system of claim 19, wherein the at least one operating characteristic of the presentation device comprises a characteristic selected from the group consisting of: a brightness setting of the presentation device; a volume setting of the presentation device; an on/off/standby state of the presentation device; and an on/off/standby state of the set-top box device.
